(19) United States
(12) Patent Application Publication
(10) Pub. No.: US 2019/0166502 A1
(43) Pub. Date: May 30, 2019

(54) SECURITY MONITORING FOR WIRELESS SENSOR NODES

(71) Applicant: Mojo Networks, LLC., Santa Clara, CA (US)

(72) Inventor: Hemant Chaskar, San Jose, CA (US)

(21) Appl. No.: 16/205,120

(22) Filed: Nov. 29, 2018

Related U.S. Application Data
(60) Provisional application No. 62/592,224, filed on Nov. 29, 2017.

(51) Int. Cl. H04W 12/12; H04L 29/08; H04L 29/06

(52) U.S. Cl. CPC H04W 12/1204; H04L 63/1483; H04L 63/1416; H04L 67/12

(57) ABSTRACT

Security monitoring for wireless sensor nodes. Specifically, the method and wireless sensor network disclosed herein entail the retrieval and analysis of log information immutably consolidated in one or more wireless sensor nodes, to detect intrusions (i.e., attacks) on the wireless sensor node(s) by unauthorized entities. The log information in any given wireless sensor node may record events, pertaining to pairing activities, connection activities, and/or data transfer activities, between the given wireless sensor node and other devices (including both authorized devices and unauthorized devices (if any)). Further, upon detection of an intrusion based on the analysis of log information, one or more actions designed to reactively address the intrusion may be performed. Moreover, a proactive approach for preventing the phishing of static passcodes used in the pairing authentication process across Bluetooth and/or Bluetooth Low Energy (BLE) wireless communications is proposed.

### CROSS-REFERENCE TO RELATED APPLICATIONS

This application claims priority under 35 U.S.C. § 119(e) to U.S. Provisional Patent Application No. 62/592,224, filed Nov. 29, 2017, which is incorporated herein by reference in its entirety.

### BACKGROUND

The deployment of wireless sensor networks across various industries—e.g., automation, automobiles, asset tracking, agriculture, personal wearables, medical devices, etc.—has since introduced an autonomous and cost-effective paradigm for monitoring and/or controlling various respective environments. With the importance of wireless sensor networks in several walks of life, security measures safeguarding the wireless sensor networks are desirable. These security measures can include techniques for detecting exploitable vulnerabilities in wireless sensor networks, detecting malicious activity, mitigating malicious activity, and so forth.

### SUMMARY

In general, in one aspect, the invention relates to a method for monitoring wireless sensor node security. The method includes establishing a connection with a wireless sensor node (WSN), retrieving log information from the WSN, analyzing the log information to obtain a log analysis result, detecting an intrusion based on the log analysis result, and performing an intrusion mitigation action (IMA) in response to detecting the intrusion.

In general, in one aspect, the invention relates to a wireless sensor network. The wireless sensor network includes at least one wireless sensor node (WSN), and an authorized gateway node (AGN) wirelessly connectable to the at least one WSN. Further, the AGN may be programmed to establish a connection with a WSN of the at least one WSN, retrieve log information from the WSN, obtain a log analysis result based on the log information, detect an intrusion based on the log analysis result, and perform an intrusion mitigation action (IMA) in response to detecting the intrusion.

In general, in one aspect, the invention relates to a non-transitory computer readable medium (CRM). The non-transitory CRM includes computer readable program code, which when executed by a computer processor, enables the computer processor to establish a connection with a wireless sensor node (WSN), retrieve log information from the WSN, analyze the log information to obtain a log analysis result, detect an intrusion based on the log analysis result, and perform an intrusion mitigation action (IMA) in response to detecting the intrusion.

Other aspects of the invention will be apparent from the following description and the appended claims.

### BRIEF DESCRIPTION OF DRAWINGS

FIG. 1A shows a wireless sensor network in accordance with one or more embodiments of the invention.

FIG. 1B shows a wireless sensor network in accordance with one or more embodiments of the invention.

FIG. 2A shows a wireless sensor node in accordance with one or more embodiments of the invention.

FIG. 2B shows a wireless sensor node memory in accordance with one or more embodiments of the invention.

FIG. 2C shows a gateway node in accordance with one or more embodiments of the invention.

FIG. 3 shows a flowchart describing a method for monitoring wireless sensor node security in accordance with one or more embodiments of the invention.

FIG. 4 shows a computing device in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

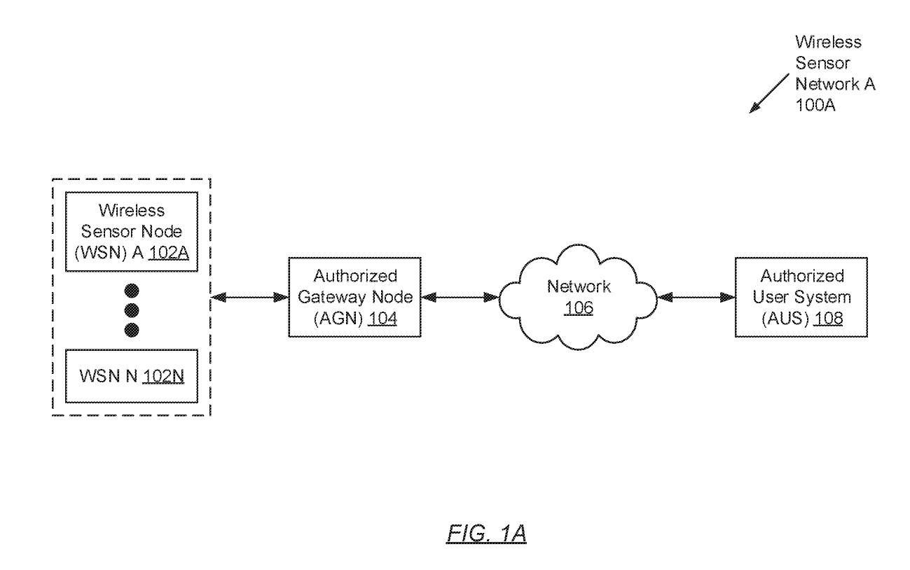

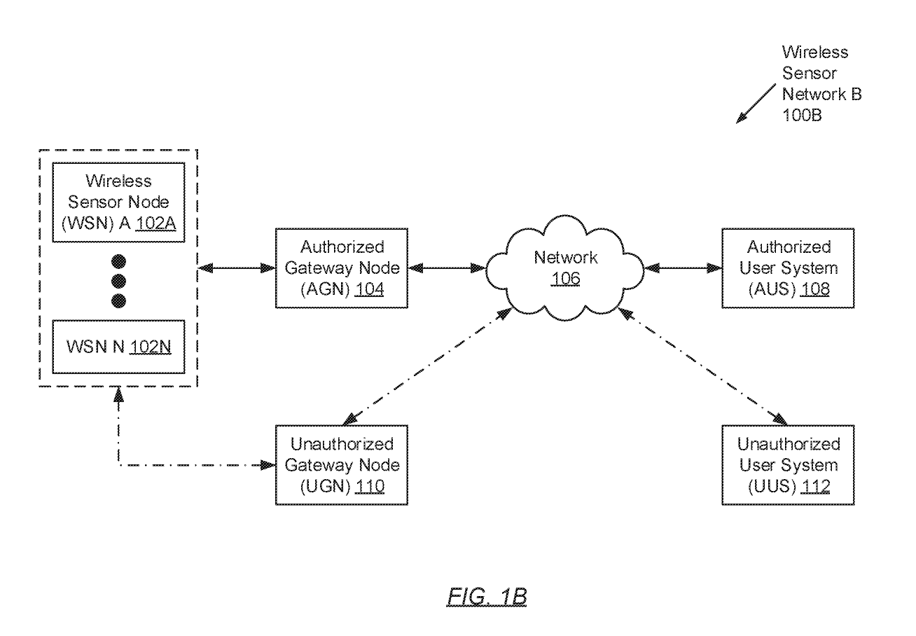

In the following description of FIGS. 1A-4, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments of the invention relate to the security monitoring for wireless sensor nodes. Specifically, one or more embodiments of the invention entail the retrieval and analysis of log information immutably consolidated in one or more wireless sensor nodes, to detect intrusions (i.e., attacks) on the wireless sensor node(s) by unauthorized entities. The log information in any given wireless sensor node may record events, pertaining to pairing activities, connection activities, and/or data transfer activities, between the given wireless sensor node and other devices (including both authorized devices and unauthorized devices (if any)). Further, upon detection of an intrusion based on the analysis of log information, one or more actions designed to reactively address the intrusion may be performed. Moreover, a proactive approach for preventing the phishing of static passcodes used in the pairing authentication process across Bluetooth and/or Bluetooth Low Energy (BLE) wireless communications is proposed.

Embodiments of the invention facilitate detection of phishing attacks on wireless sensor nodes. Wireless sensor nodes may be exposed to phishing attacks due to limitations of their wireless protocols and/or device implementations. In one embodiment, a phishing attack may entail an unauthorized device forming a wireless connection with the wireless sensor node in order to steal or manipulate its data and/or manipulate its actions. This creates a security vulnerability for a wireless sensor network. Accordingly, embodiments of the invention provide benefits and/or advantages by providing techniques to detect such phishing attacks. Further, embodiments of the invention may facilitate reacting to the phishing attacks to mitigate their presence and/or effects.

FIG. 1A shows a wireless sensor network in accordance with one or more embodiments of the invention. The wireless sensor network (100A) may represent a network formed from one or more spatially distributed devices that may often be deployed to monitor physical and/or environmental conditions. Accordingly, the wireless sensor network (100A) may include one or more wireless sensor nodes (WSNs) (102A-102N) wirelessly linked to an authorized gateway node (AGN) (104), which operatively connects to an authorized user system (AUS) (108) through a network (106). Each of these components is described below.

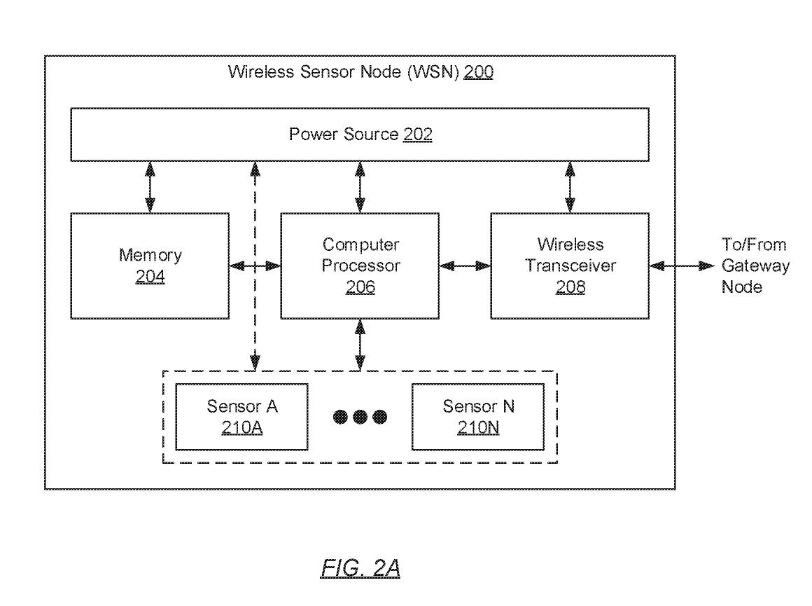

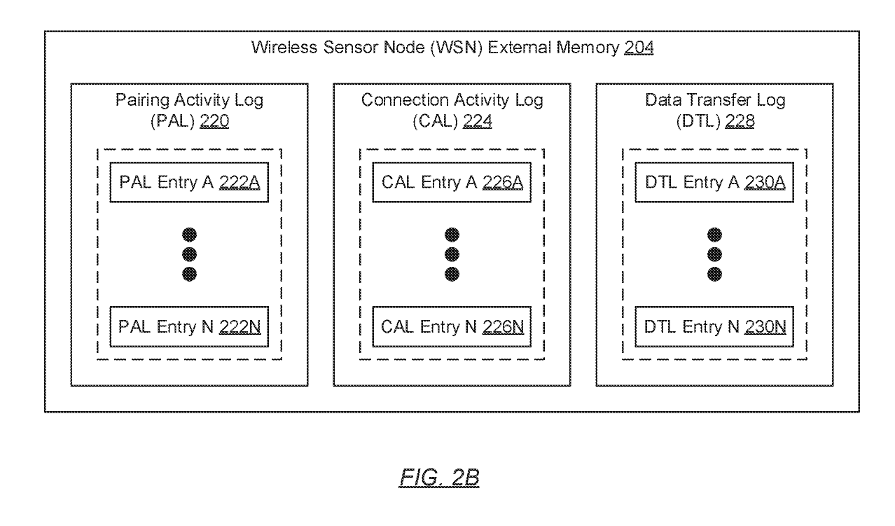

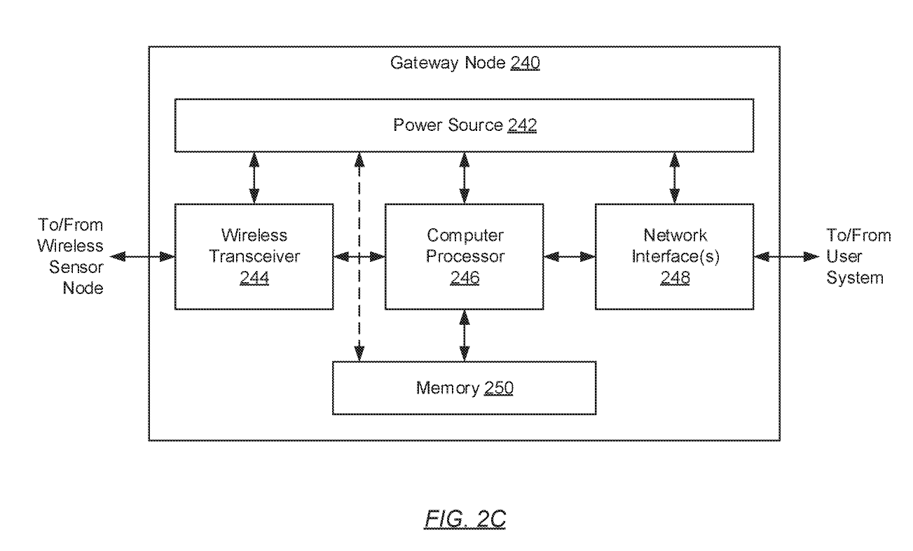

In one embodiment of the invention, each WSN (102A-102N) may represent a physical device that gathers sensory information. Sensory information may refer to measurable responses to changes in an environment—e.g., the environment that which the WSN (102A-102N) may be monitoring. Further, each WSN (102A-102N) may include additional functionality to: perform some processing—e.g., analog to digital sensory information conversions; communicate sensory (and/or other) information to one or more gateway nodes—e.g., the AGN (104); maintain log information detailing pairing activity, connection activity, and/or data transfer activity with other devices (described below); and receive queries, instructions, and/or updates from one or more gateway nodes. One of ordinary skill will appreciate that each WSN (102A-102N) may perform other functionalities without departing from the scope of the invention, such as, for example, performing an action to bring out a physical effect in the environment. The WSN (102A-102N) is described in further detail below with respect to FIG. 2A.

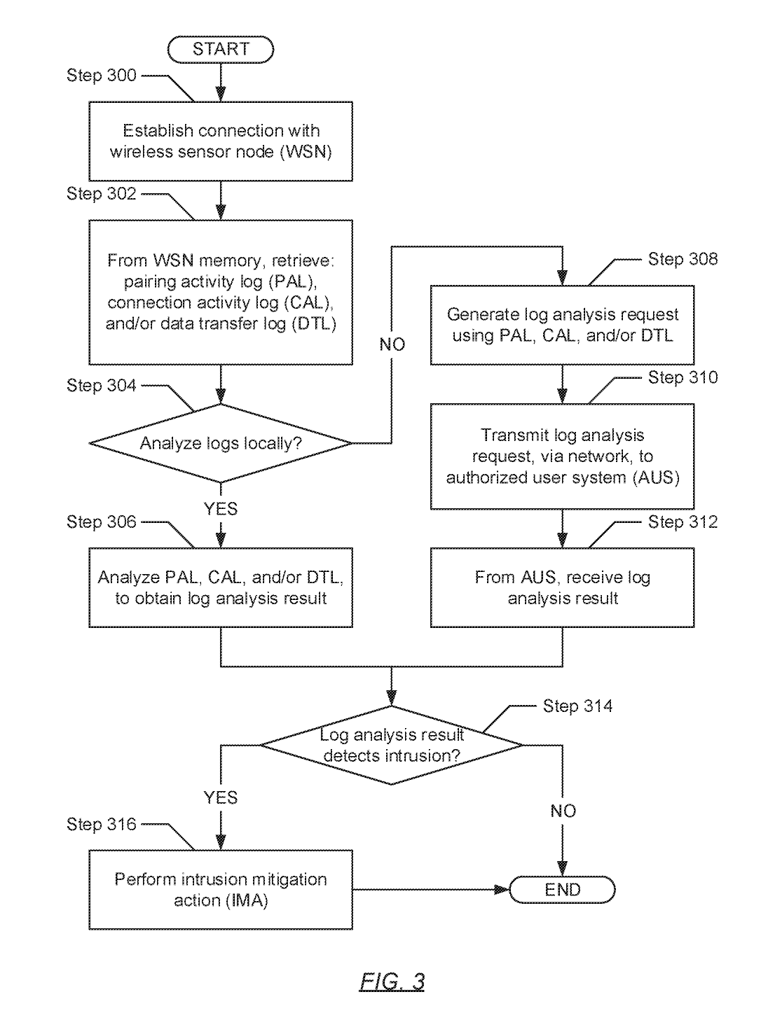

In one embodiment of the invention, the AGN (104) may represent any gateway node that is authorized to interact with the one or more WSNs (102A-102N). More specifically, the AGN (104) may represent a physical device that serves as a wireless sensor network coordinator and/or interface between different networks. With respect to wireless sensor network coordination, the AGN (104) may include functionality to: manage the one or more WSNs (102A-102N), and communicate with the one or more WSNs (102A-102N) through the receipt of sensory, log, and/or other information therefrom and/or through the transmission of queries, commands, updates, etc. thereto. Further, with respect to interfacing different networks, the AGN (104) may include functionality to perform communication protocol conversion, thereby facilitating the exchange of information between the one or more WSNs (1.02A-102N), which may form one network, and one or more user systems—e.g., the AUS (108)—which operate within another network (106). In one embodiment of the invention, the AGN (104) may include further functionality to monitor wireless sensor network security and mitigate the detection of intrusions (if any) in accordance with one or more embodiments of the invention (see e.g., FIG. 3). Moreover, one of ordinary skill will appreciate that the AGN (104) may perform other functionalities without departing from the scope of the invention. Gateway nodes, such as the AGN (104), are described in further detail below with respect to FIG. 2C.

In one embodiment of the invention, the network (106) may represent a structured arrangement of various interconnected devices, which may work together to facilitate communications, information exchange, resource sharing, etc. By way of examples, the network (106) may be a local area network (LAN), a wide area network (WAN) such as the Internet, a mobile network, any other type of network, or a combination thereof. Further, the network (106) may be implemented using any combination of wired and/or wireless communication pathways, which may employ any combination of wired and/or wireless communication protocols. Moreover, the network (106) may at least include functionality to operatively connect one or more gateway nodes—e.g., the AGN (104)—to one or more user systems—e.g., the AUS (108). One of ordinary skill will appreciate that the network (106) may perform other functionalities without departing from the scope of the invention.

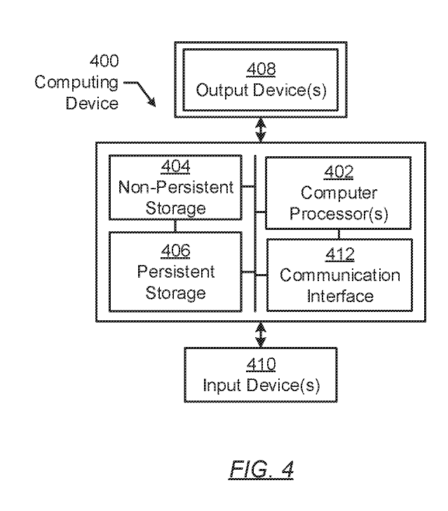

In one embodiment of the invention, the AUS (108) may represent any computing system authorized to interact with the AGN (10.4) and/or the one or more WSNs (102A-102N). More specifically, the AUS (108) may represent one or more physical (and/or virtual) computing devices that work together to implement one or more applications and./or services—e.g., data processing and/or analyses. Further, the AUS (108) may include functionality to: receive sensory, log, and/or other information from the one or more WSNs (102A-102N) via the AGN (104); issue queries, instructions, updates, log analysis results (described below) to the AGN (104) and/or the one or more WSNs (102A-102N) via, the AGN (104); and analyze log information (described below) retrieved from the one or more WSNs (102A-102N) to detect wireless sensor network intrusions should the analysis be delegated to the AUS (108) in lieu of being performed locally by the AGN (104). One of ordinary skill will appreciate that the AUS (108) may perform other functionalities without departing from the scope of the invention. Examples of computing devices, which may form the AUS (108), may include, but are not limited to: desktop computers, laptop computers, tablet computers, servers, mainframes, smartphones, or any other computing devices similar to the exemplary computing device shown in FIG. 4.

While FIG. 1A shows a configuration of components, other wireless sensor network configurations may be used without departing from the scope of the invention. For example, refer to FIG. 1B below.

FIG. 1B shows a wireless sensor network in accordance with one or more embodiments of the invention. In addition to the one or more wireless sensor nodes (102A-102N), the authorized gateway node (AGN) (104), the network (106), and the authorized user system (AUS) (108) described above in FIG. 1A, this wireless sensor network (100B) configuration further includes an unauthorized gateway node (UGN) (110) wirelessly connectable to the WSN(s) (102A-102N) and operatively connected, via the network (106), to an unauthorized user system (UUS) (112). Each of these additional components is described below.

In one embodiment of the invention, the UGN (110) may represent any gateway node that is not authorized to interact with the one or more WSNs (102A-102N). More specifically, the UGN (110) may represent a physical device that serves as an access point for malicious activities targeting the one or more WSNs (102A-102N). With respect to participating in malicious activities directed to the one or more WSNs (102A-102N), the UGN (110) may include functionality to facilitate one or more intrusions (described below) onto the one or more WSNs (102A-102N). Moreover, one of ordinary skill will appreciate that the UGN (110) may perform other functionalities without departing from the scope of the invention. Gateway nodes, such as the UGN (110) and the AGN (104), are described in further detail below with respect to FIG. 2C.

In one embodiment of the invention, an intrusion may represent an attack to one or more WSNs (102A-102N) with the objective of gaining unauthorized access to information (e.g., sensory information, configuration information, etc.) stored on the one or more WSNs (102A-102N), gaining unauthorized access to the service(s) provided by or implemented through the one or more WSNs (102A-102N), and/or issuing unauthorized commands to the one or more WSNs (102A-102N). Alternatively, an intrusion may pertain to an attack, which directly impairs the intended functionality of the one or more WSNs (102A-102N)—e.g., faulty data injection into one or more WSNs (102A-102N), impersonation of one or more WSNs (102A-102N), modification of the outgoing sensory information transmitted by one or more WSNs (102A-102N), exploitation of vulnerabilities in security protocols deployed on the one or more WSNs (102A-102N), degradation of WSN performance, etc.

In one embodiment of the invention, the UUS (112) may represent any computing system not authorized to interact with the one or more WSNs (102A-102N). More specifically, the UUS (112) may represent one or more physical (and/or virtual) computing devices that work together to orchestrate any malicious activities targeting the one or more WSNs (102A-102N). To that extent, the UUS (112) may include functionally to: direct one or more attacks, via the UGN (110), onto one or more WSNs (102A-102N); issue unauthorized and/or unwanted queries, instructions, etc. to one or more WSNs (102A-102N); receive unauthorized and/or unwanted access to sensory, log, and/or other information consolidated on one or more WSNs (102A-102N); and/or perform other malicious activities that may lead to similar or other undesirable outcomes. One of ordinary skill will appreciate that the UUS (112) may perform other functionalities without departing from the scope of the invention. Examples of computing devices, which may form the UUS (112), may include, but are not limited to: sensory devices, desktop computers, laptop computers, tablet computers, servers, mainframes, smartphones, or any other computing devices similar to the exemplary computing device shown in FIG. 4.

While FIG. 1B shows a configuration of components, other wireless sensor network configurations may be used without departing from the scope of the invention. For example, more than one set of WSNs (102A-102N) and/or more than one AGN (104) may be deployed.

FIG. 2A shows a wireless sensor node (WSN) in accordance with one or more embodiments of the invention. The WSN (200) may include a power source (202), memory (204), a computer processor (206), a wireless transceiver (208), and one or more sensors (210A-210N). Each of these subcomponents is described below.

In one embodiment of the invention, the power source (202) may represent any portable storage medium and supplier of direct current (DC) for powering the various other subcomponents of the WSN (200). Accordingly, the power source (202), via physical wired pathways (not shown), may provide DC to the memory (204), the computer processor (206), the wireless transceiver (208), the one or more sensors (210A-210N), and other miscellaneous subcomponents (not shown)—e.g., analog to digital converter (ADC), input devices, output devices, etc. By way of an example, the power source (202) may encompass a disposable or rechargeable battery, which may include, but is not limited to, one or more nickel cadmium, nickel zinc, nickel metal hydride, lithium ion, carbon zinc, alkaline, or any other type of power cells.

In one embodiment of the invention, the memory (204) may represent any data storage device that implements addressable data storage on the WSN (200). The memory (204) may store various forms of information pertinent to the WSN (200)—e.g., log information (described below), sensory information, etc. Further, information consolidation on and/or retrieval from the memory (204) may be performed by the computer processor (206). The memory (204) may be embodied as data storage that may include, but is not limited to, NAND flash memory, NOR flash memory, universal serial bus (USB) flash drives, secure digital (SD) cards, compact flash (CF) cards, random access memory (RAM), dynamic RAM (DRAM) or any other appropriate data storage. The memory (204) is described in further detail below with respect to FIG. 2B.

In one embodiment of the invention, the computer processor (206) may represent one or more integrated circuits for processing instructions. By way of examples, the computer processor (206) may be implemented using an application specific integrated circuit (ASIC), a field programmable gate array (FPGA), a microcontroller, a discrete processor, a digital signal processor (DSP), or any other type of integrated circuit for processing instructions. Further, the aforementioned instructions, processed by the computer processor (206), may encompass computer readable program code, which may enable the computer processor (206) to, for example, control the functionalities of the various other WSN (200) subcomponents, coordinate information interchange between the various WSN (200) subcomponents (including itself), pre-process sensory information gathered by the WSN (200), track log information (described below) detailing interactions between the WSN (200) and other devices, etc. One of ordinary skill will appreciate that the computer processor (206), through the execution of computer readable program code, may perform other functionalities without departing from the scope of the invention.

In one embodiment of the invention, the wireless transceiver (208) may represent a physical, communication-enabling device that includes a receiver antenna, for receiving information, and a transmitter antenna for transmitting information. The wireless transceiver (208) may receive and/or transmit information wirelessly (i.e., without a wired medium) through a wireless link that may operatively connect the WSN (200) and at least one other device—e.g., another WSN (200) or a gateway node (see e.g., FIGS. 1A, 1B, and 2C). Further, the wireless transceiver (208) may include functionality to: obtain outgoing information—e.g., sensory information, log information (described below), etc.—from the computer processor (206); modulate the outgoing information onto a carrier wave tuned to a desired wireless frequency band, to obtain a modulated carrier wave; transmit the modulated carrier wave to another wireless transceiver (not shown) on at least one other device; receive another modulated carrier wave tuned to the desired wireless frequency band from the at least one other device; demodulate the received modulated carrier wave, to extract incoming information—e.g., queries, instructions, updates, etc.; and provide the extracted incoming information to the computer processor (206). Examples of wireless connectivity protocols that may be employed by the wireless transceiver (208) to receive and/or transmit information include, but are not limited to, the ZigBee protocol, the Wireless Highway Addressable Remote Transducer (WirelessHART) protocol, the Bluetooth and/or Bluetooth Low Energy (BLE) protocol, the Wireless Universal Serial Bus (Wireless USB) protocol, etc.

In one embodiment of the invention, each sensor (210A-210N) may represent a physical device that detects or measures changes to a physical property or stimulus e.g., heat, light, sound, pressure, magnetism, motion, etc. observed within an environment. Further, each sensor (210A-210N) may transduce these observed changes to a physical property/stimulus into an analog and/or digital signal, which can be interpreted by the computer processor (206). In one embodiment of the invention, the sensory information referred throughout this disclosure may encompass the aforementioned analog and/or digital signals, which capture the changes to one or more physical properties/stimuli detected or measured by one or more sensors (210A-210N). Examples of sensors (210A-210N) that may be found on the WSN (200) include, but are not limited to: accelerometers, acoustic sensors, capacitance sensors, electrocardiogram (ECG) electrodes, electroencephalogram (EEG) electrodes, electromyography (EMG) electrodes, gyroscopes, humidity sensors, infrasonic sensors, magnetometers, oximeters, temperature sensors, seismic sensors, microphones, radars, etc.

While FIG. 2A shows a configuration of subcomponents, other WSN configurations may be employed without departing from the scope of the invention. For example, the WSN (200) may additionally include one or more input devices (not shown)—e.g., a touchpad, a touchscreen, a keyboard, etc. By way of another example, the WSN (200) may further include one or more output devices (not shown)—e.g., a screen, a speaker, light emitting diodes (LEDs), etc. By way of another example, the WSN (200) may additionally include one or more action elements (e.g., actuators), which may enable the WSN (200) to effect a change in the enviromnent that which the WSN (200) may be monitoring.

FIG. 2B shows a wireless sensor node (WSN) memory in accordance with one or more embodiments of the invention. As described above, WSN memory (204) may represent any data storage device that implements addressable data storage on the WSN (not shown). Further, WSN memory (204) may store various forms of information pertinent to the WSN such as, for example, sensory information (described above) (not shown) and log information. Log information may collectively refer to maintained documentation that records events, pertinent to certain activities or operations, occurring on or involving the WSN. Moreover, log information may be maintained using a pairing activity log (PAL) (220), a connection activity log (CAL) (224), and/or a data transfer log (DTL) (228). Each of these logs is described below.

In one embodiment of the invention, the PAL (220) may represent documentation or a data structure that maintains a chronologically indicated list of events detailing attempted and/or completed pairing processes between the WSN and one or more other devices—e.g., other WSNs, gateway nodes, etc. A pairing process may refer to a one-time, initial information interchange session between two (or a pair) of devices —e.g., the WSN and another device. The objective of the pairing process may be directed to establishing permission that the two devices may communicate with one another. Further, during the pairing process, each participating device may exchange certain information associated with itself, which may include, but is not limited to: an identifier or address that uniquely identifies the device; a name or designation assigned to the device; a device type or category associated with the device; and a passcode or passkey that authenticates the proposed pairing to the other participating device.

Furthermore, in one embodiment of the invention, the PAL (220) may track one or more pairing process events through one or more PAL entries (222A-222N), respectively. Each PAL entry (222A-222N) may specify pairing activity information describing an attempted or completed pairing process between the WSN and another device. The aforementioned pairing activity information may include, but is not limited to: an identifier or address that uniquely identifies the other device; a name or designation assigned to the other device; a pairing method employed to implement the pairing process (e.g., for Bluetooth: Just Works, Passkey Entry, Out-of-Band (OOB), Numeric Comparison, etc.); an event timestamp encoding a date and/or time at which the pairing process transpired; an event type (e.g., device pairing or device unpairing) describing the nature of the pairing process; a device type or category associated with the other device; and an outcome of the pairing process (e.g., failed or succeeded).

In one embodiment of the invention, the CAL (224) may represent documentation or a data structure that maintains a chronologically indicated list of events detailing established connection processes between the WSN and one or more other devices—e.g., other WSNs, gateway nodes_{;} etc. A connection process may refer to any post-pairing information interchange session between two (or a pair) of devices—e.g., the WSN and another device. Further, during a connection process, either participating device may communicate with the other participating device regularly at predetermined intervals of time.

Furthermore, in one embodiment of the invention, the CAL (224) may track one or more connection process events through one or more CAL entries (226A-226N), respectively. Each CAL entry (226A-226N) may specify connection activity information describing an established connection process between the WSN and another device. The aforementioned connection activity information may include, but is not limited to: an identifier or address that uniquely identifies the other device; a name or designation assigned to the other device; an event timestamp encoding a date and/or time at which the connection process transpired; an event type (e.g., connection start or connection end) describing the connection event; a device type or category associated with the other device; and an outcome of the connection process (e.g., failed or succeeded).

In one embodiment of the invention, the DTL (228) may represent documentation or a data structure that maintains a chronologically indicated list of events detailing data transfer processes between the WSN and one or more other devices—e.g., other WSNs, gateway nodes, etc. A data transfer process may refer to any point-to-point transfer of information that transpires while two (or a pair) of devices—e.g., the WSN and another device—may be connected. Further, a data transfer process may be defined as: (a) the outgoing transfer of sensory, log, and/or other information from the WSN to the other device; (b) the incoming transfer of queries, instructions, and/or updates from the other device to the WSN; or (c) a combination thereof.

Furthermore, in one embodiment of the invention, the DTL (228) may track one or more data transfer process events through one or more DTL entries (230A-230N), respectively. Each DTL entry (230A-230N) may specify data transfer information describing an outgoing transfer of information from the WSN to another device, or an incoming transfer of information from the other device to the WSN. The aforementioned data transfer information may include, but is not limited to, a data volume and a data identity.

FIG. 2C shows a gateway node in accordance with one or more embodiments of the invention. The gateway node (240)—e.g., an authorized gateway node (AGN) or an unauthorized gateway node (UGN) (see e.g., FIGS. 1A and 1B)—may include a power source (242), a wireless transceiver (244), a computer processor (246), one or more network interfaces (248), and memory (250). Each of these subcomponents is described below.

In one embodiment of the invention, the power source (242) may represent any portable storage medium and supplier of direct current (DC) for powering the various other subcomponents of the gateway node (240). Accordingly, the power source (242), via physical wired pathways (not shown), may provide DC to the wireless transceiver (244), the computer processor (246), the network interface(s) (248), the memory (250), and other miscellaneous subcomponents (not shown)—e.g., input devices, output devices, etc. By way of an example, the power source (242) may encompass a disposable or rechargeable battery, which may include, but is not limited to, one or more nickel cadmium, nickel zinc, nickel metal hydride, lithium ion, carbon zinc, alkaline, or any other type of power cells.

In one embodiment of the invention, the wireless transceiver (244) may represent a physical, communication-enabling device that includes a receiver antenna, for receiving information, and a transmitter antenna for transmitting information. The wireless transceiver (244) may receive and/or transmit information wirelessly (i.e., without a wired medium) through a wireless link that may operatively connect the gateway node (240) and at least one other device—e.g., a wireless sensor node (WSN) (not shown) (see e.g., FIGS. 1A, 1B, and 2A). Further, the wireless transceiver (244) may include functionality to: obtain outgoing information—e.g., queries, instructions, updates, etc.—from the computer processor (246); modulate the outgoing information onto a carrier wave tuned to a desired wireless frequency band, to obtain a modulated carrier wave; transmit the modulated carrier wave to another wireless transceiver (not shown) on at least one other device; receive another modulated carrier wave tuned to the desired wireless frequency band from the at least one other device; demodulate the received modulated carrier wave, to extract incoming information—e.g., sensory information, log information, etc.; and provide the extracted incoming information to the computer processor (2.46). Examples of wireless connectivity protocols that may be employed by the wireless transceiver (244) to receive and/or transmit information include, but are not limited to, the ZigBee protocol, the Wireless Highway Addressable Remote Transducer (WirelessHART) protocol, the Bluetooth and/or Bluetooth Low Energy (BLE) protocol, the Wireless Universal Serial Bus (Wireless USB) protocol, etc.

In one embodiment of the invention, the computer processor (246) may represent one or more integrated circuits for processing instructions. By way of examples, the computer processor (246) may be implemented using an application specific integrated circuit (ASIC), a field programmable gate array (FPGA), a microcontroller, a discrete processor, a digital signal processor (DSP), or any other type of integrated circuit for processing instructions. Further, the aforementioned instructions, processed by the computer processor (246), may encompass computer readable program code, which may enable the computer processor (2.46) to, for example, control the functionalities of the various other gateway node (240) subcomponents, coordinate information interchange between the various gateway node (240) subcomponents (including itself); process and/or relay the sensory, log, and/or other information retrieved from one or more WSNs to a respective user system—e.g., an AGN to an authorized user system (AUS) (see e.g., FIG. 1A) or an UGN to an unauthorized user system (UUS) (see e.g., FIG. 1B); and process and/or relay queries, instructions, and/or updates received from a respective user system to one or more WSNs. One of ordinary skill will appreciate that, generally, the computer processor (246) of any given gateway node (240) may perform other functionalities without departing from the scope of the invention.

In one embodiment of the invention, the computer processor (246) of an AGN may include further functionality to: analyze received log information from any given WSN, or delegate the analysis of the received log information to an authorized user system (AUS) (see e.g., FIG. 1A), in order to obtain log analysis results; detect or not detect an intrusion of the given WSN using or based on the obtained log analysis results; and if an intrusion is detected, perform one or more intrusion mitigation actions (IMAs) (described below) to address the intrusion.

In one embodiment of the invention, each network interface (248) may represent a physical or virtual device that acts as a point of interconnection between the gateway node (240) and a network—e.g., any network operatively connecting the gateway node (240) to a respective user system (see e.g., FIGS. 1A and 1B). Each network interface (248) may be configured as an ingress network interface, which receives information from one or more devices on the network; or, alternatively, as an egress network interface, which transmits information to one or more devices on the network. Further, the received and/or transmitted information may take form as one or more data packets, which traverse the network using one or more networking protocols—e.g., the Internet Protocol (IP), the Transmission Control Protocol (TCP), the Hypertext Transfer Protocol (HTTP), the User Datagram Protocol (UDP), etc. Accordingly, an ingress network interface (248) may include functionality to: receive one or more incoming data packets (e.g., representative of queries, instructions, updates, log analysis results (described above), etc.) from a respective user system via the network; translate or convert the received incoming data packet(s) into computer-interpretable information; and provide the computer-interpretable information to the computer processor (246). On the other hand, an egress network interface (248) may alternatively include functionality to: obtain computer-interpretable information (e.g., representative of sensory information, log information, log analysis requests, etc.) from the computer processor (246); translate or convert the computer-interpretable information into one or more data packets; and transmit the data packet(s) to the respective user system via the network. Examples of network interfaces (248) may include, but are not limited to: network interface cards or controllers (NICs), network adapters, network sockets (e.g., software-implemented or virtual network interfaces), etc.

In one embodiment of the invention, the memory (250) may represent any data storage device that implements addressable data storage on the gateway node (240). The memory (250) may store various forms of information pertinent to the gateway node (240) e.g., log information from one or more WSNs, sensory information from one or more WSNs, etc. Further, information consolidation on and/or retrieval from the memory (250) may be performed by the computer processor (246). The memory (250) may be embodied as data storage that may include, but is not limited to, NAND flash memory, NOR flash memory, universal serial bus (USB) flash drives, secure digital (SD) cards, compact flash (CF) cards, random access memory (RAM), dynamic RAM (DRAM) or any other appropriate data storage.

While FIG. 2C shows a configuration of subcomponents, other gateway node configurations may be employed without departing from the scope of the invention. For example, the gateway node (240) may additionally include one or more input devices (not shown)—e.g., a touchpad, a touchscreen, a keyboard, etc. By way of another example, the gateway node (240) may further include one or more output devices (not shown) —e.g., a screen, a speaker, light emitting diodes (LEDs), etc.

FIG. 3 shows a flowchart describing a method for monitoring wireless sensor node security in accordance with one or more embodiments of the invention. The various steps outlined below may be performed by an authorized gateway node (AGN) (see e.g., FIGS. 1A and 1B). Further, while the various steps in the flowchart are presented and described sequentially, one of ordinary skill will appreciate that some or all steps may be executed in different orders, may be combined or omitted, and some or all steps may be executed in parallel.

Turning to FIG. 3, in Step 300, a connection is established with a wireless sensor node (WSN). In one embodiment of the invention, in establishing the connection, information may be transmitted wirelessly to the WSN and/or may be received wirelessly from the WSN. Further, prior to establishing the connection, a pairing process (described above) (see e.g., FIG. 2B) with the WSN may be required. In successfully performing the pairing process, permission to communicate with the WSN as an authorized party is authenticated.

In Step 302, log information is retrieved from the WSN. In one embodiment of the invention, the log information may be maintained in an memory (see e.g., FIGS. 2A and 2B) of the WSN and, accordingly, may be retrieved therefrom. The memory, at least in part or in entirety, may restrict the modification of data written therein. In one embodiment of the invention, the modification to information (e.g., log information) stored in the memory may only be explicitly accomplished by the computer processor within the WSN following pre-programmed and potentially immutable instructions. In another embodiment of the invention, the modification to information (e.g., log information) stored in the memory may only be explicitly accomplished by instructions running under special operating system privilege, where such a privilege may not be available to devices connecting to the WSN during normal operation. In yet another embodiment of the invention, the modification to information (e.g., log information) stored in the memory may only be explicitly accomplished by whitelisted devices, such as the WSN itself and an AGN that may be connecting to the WSN, but not by other devices such as a UGN that may be connecting to the WSN. In another embodiment of the invention, the modification to information (e.g., log information) stored in the memory may only be explicitly accomplished under special circumstances, for example, when an authorized fingerprint (e.g., a credential that is generated using a hash function) is provided to the WSN, or when a password is entered into the WSN. One of ordinary skill will appreciate that additional or alternative methods for restricting the modification of data within the memory may be employed without departing from the scope of the invention.

Further, in one embodiment of the invention, the log information may include information tracked and stored in any subset or all of the following: (a) a pairing activity log (PAL); (b) a connection activity log (CAL); and (c) a data transfer log (DTL). In one embodiment of the invention, the log information may be recorded in a portion of the memory that restricts the modification of data written therein. Within the PAL, pairing activity information—describing attempted or completed pairing processes between the WSN and one or more other devices (e.g., other WSNs, one or more authorized gateway nodes (AGNs) (see e.g., FIG. 1A) and/or unauthorized gateway nodes (UGNs) (see e.g., FIG. 1B)—is recorded. Within the CAL, connection activity information—describing established connection processes between the WSN and one or more other devices—is recorded. Within the DTL, data transfer information—describing outgoing transfers of information from the WSN to one or more other devices, and/or incoming transfers of information from one or more other devices to the WSN—is recorded.

In Step 304, a determination is made as to whether the log information (retrieved from the WSN in Step 302) is to be analyzed locally—i.e., on the AGN, which may be performing the method outlined in FIG. 3. The determination may entail interpreting pre-programmed instructions, which may either instruct the AGN to perform the log information analyses locally or, alternatively, to delegate the execution of the log information analyses to a specified remote system. Accordingly, in one embodiment of the invention, if it is determined that the analyses of the log information are to be performed locally,then the process may proceed to Step 306. On the other hand, if it is alternatively determined that the analyses of the log information are to be performed remotely, then the process may alternatively proceed to Step 308.

In Step 306, after determining (in Step 304) that the analyses of the log information (retrieved in Step 302) are to be performed locally, the log information is analyzed to obtain a log analysis result. The log analysis result may represent a report, which may outline the outcome(s) of the analyses and a confidence based determination on whether an intrusion has been attempted and/or has succeeded on the WSN. In one embodiment of the invention, analyzing the log information may entail: performing a search on the log information to identify each identifier or address uniquely identifying a device that had paired, connected, and/or transferred data with the WSN; cross-checking the identified identifiers/addresses against a whitelist of identifiers/addresses authorized to interact with the WSN; and detecting that an intrusion on the WSN (and/or the wireless sensor network that which the WSN partly forms) has been attempted and/or successfully occurred should at least one identified identifier/address (recorded in the log information) not match any of the authorized identifiers/addresses specified in the whitelist. In another embodiment of the invention, analyzing the log information may entail determining characteristics such as instances, frequency and/or durations with which one or more devices had paired, connected, and/or transferred data with the WSN; cross-checking the identified characteristics with acceptable thresholds; and detecting that an intrusion on the WSN (and/or the wireless sensor network that which the WSN partly forms) has been attempted and/or successfully occurred should at least one of the characteristics (analyzed from log information) not meet acceptable thresholds. Hereinafter, the process proceeds to Step 314.

In Step 308, after alternatively determining (in Step 304) that the analyses of the log information (retrieved in Step 302) are to be performed remotely, a log analysis request is generated. In one embodiment of the invention, the log analysis request may pertain to analyzing the log information off-site. Further, the log analysis request may be generated using, and thus may include, the log information.

In Step 310, the log analysis request (generated in Step 308) is transmitted. Specifically, in one embodiment of the invention, the log analysis request may be transmitted, through a network, to an authorized user system (AUS) (see e.g., FIG. 1A). The AUS may represent any computing system authorized to interact with the AGN and the WSN (with which a connection had been established in Step 300). Thereafter, in response to submitting the log analysis request, in Step 312, a log analysis result is received from the AUS. In one embodiment of the invention, the log analysis result may represent a report, which may outline the outcome(s) of the analyses (performed by the AUS on the log information) and a confidence based determination on whether an intrusion has been attempted and/or has successfully occurred on the WSN. The analyses on the log information, performed by the AUS, may be substantially similar to the analyses described above in Step 306, which may be performed locally by the AGN. Hereinafter, the process proceeds to Step 314.

In Step 314, after either analyzing the log information locally (in Step 306) or remotely (in Step 312) to obtain the log analysis result, a determination is made as to whether one or more intrusions—e.g., attempted and/or successful—on the WSN have been detected. Accordingly, in one embodiment of the invention, if it is determined, based on the log analysis result, that one or more intrusions have been detected, then the process may proceed to Step 316. On the other hand, in another embodiment of the invention, if it is alternatively determined, based on the log analysis result, that no intrusions have been detected, then the process alternatively ends.

In Step 316, after determining (in Step 314) that one or more intrusions directed to the WSN (and/or the wireless sensor network) have been detected, one or more intrusion mitigation actions (IMAs) is/are performed. An IMA may represent a task or process that directly or indirectly leads to the containment, reduction, or elimination of the one or more detected intrusions and their resulting effects on the WSN and/or wireless sensor network. In one embodiment of the invention, an IMA may entail issuing a hard (or master) reset command to the WSN which may prompt the WSN to re-initialize itself, thereby wiping any unwanted effects introduced by the detected intrusion(s,). In another embodiment of the invention, an IMA may additionally or alternatively entail generating an alert to an administrator, who in turn can do physical remediation on the WSN or application utilizing the WSN. For example, upon identifying an intrusion, the historical data of an application may be examined to identify if any unwanted effects may have impacted the performance of the application due to the intrusion.

FIG. 4 shows a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

Modification of Bluetooth Security Protocols

In one embodiment of the invention, intrusions directed to one or more WSNs may be proactively mitigated or prevented through modification of currently deployed Bluetooth and/or Bluetooth Low Energy (BLE) security protocols. Details outlining the most recent security protocols in place for safeguarding Bluetooth- and/or BLE-enabled communications against, for example, passive eavesdropping, may be found in the Bluetooth Core Specification Version 5.0 (hereinafter referred to as “Bluetooth Specification”), dated Dec. 6, 2016 and published by the Bluetooth Special Interest Group (SIG), which is incorporated herein by reference in its entirety.

Summarily, Bluetooth and/or BLE communications, as discussed above, employs pairing processes to perform authentication between two (or a pair) of devices. These pairing processes are necessary before connections may be established between the devices, which in turn, are prerequisites for the interchange of information (i.e., the transfer of data) between the devices. The pairing methods or models employed to implement these pairing processes include, but are not limited to: (a) the Numeric Comparison method/model, which is designed for scenarios where both devices are capable of displaying a six digit number and both are capable of having a user enter “yes” or “no”; (b) the Just Works method/model, which is designed for scenarios where at least one of the devices does not have a display capable of displaying a six digit number nor does it have a keyboard capable of entering six decimal digits; (c) the Out of Band (OOB) method/model, which is designed for scenarios where an OOB mechanism (e.g., implemented as either a read-only (one-way) authentication scheme or read/write (two-way) authentication scheme) is used to both discover the devices as well as exchange or transfer cryptographic numbers used in the pairing process; and (d) the Passkey Entry method/model, which is designed for scenarios where one device has input capability but does not have the capability to display six digits and the other device only has output capabilities.

Furthermore, regarding the Passkey Entry method/model, any given pair of devices may perform an authentication handshake to ensure that passcode (e.g., a six digit passkey or number) matches on both the devices. The authentication handshake may entail the transmission of multiple messages in each direction. Each message may include a hash value derived from a combination of the following information: one bit of the passcode, two random numbers (e.g., nonces), and public encryption keys associated with the two devices. The hash value may represent a numeric value, which may be obtained from processing the combination of the aforementioned information through a hashing algorithm—e.g., the Advanced Encryption Standard (AES)-Cipher-based Message Authentication Code (CMAC) algorithm By way of an example, a six digit passcode may be encoded as a 20-bit binary number. Subsequently, the authentication handshake between devices, which employs the six digit passcode, may require the exchange of 20 messages in each direction—i.e., one message for each bit of the 20-bit binary number in each direction.

Moreover, in scenarios when at least one of the devices (e.g., a WSN) has neither a six digit display nor a numeric keypad, the six digit passcode—used in the Passkey Entry method/model for implementing pairing processes—may need to be pre-configured into the at least one device. However, the employment of pre-configured (or static) passcodes may introduce vulnerabilities to Bluetooth and/or BLE security: protocols, which can be exploited through attacks such as phishing attacks. That is, in referencing the above example concerning the exchange of 20 messages to transmit a six digit passcode in each direction, a phishing attacker (e.g., a UGIT and/or UUS) may succeed in cracking the six digit passcode in up to 20 pairing attempts, thus facilitating the rogue or unauthorized control of the at least one device (e.g., a WSN).

More specifically, cracking the six digit passcode, by the phishing attacker, may entail, during an authentication handshake between the phishing attacker and the at least one device: guessing the first bit of the 20 bits representative of the static six digit passcode; and (i) if the message succeeds in matching the first bit, then the phishing attacker identifies the first bit as having the binary value that which was guessed and, subsequently, proceeds in guessing the second bit of the 20 bits; or (ii) if the message fails in matching the first bit, then the phishing attacker identifies the first bit as having the binary value that is opposite of the binary value that which was guessed and, accordingly, terminates the pairing authentication handshake and attempts another authentication handshake using the correct first bit binary value. Further, the above methodology may be used by the phishing attacker for each successive bit representative of the digit passcode, which may entail up to 20 pairing attempts (at least for this example), until the correct sequence of bit binary values, representative of the passcode, is identified.

Towards at least addressing the above-mentioned vulnerability in using static passcodes, embodiments of the invention propose modifying the current authentication handshake protocol, performed between two devices, by reducing the number of messages exchanged in each direction. That is, in one embodiment of the invention, instead of requiring the exchange of N messages to convey the N bits of a given static passcode, the authentication handshake should rather enforce the exchange of, for example, one or up to a handful of messages with the condition that each message conveys a large enough subset of the N bits—e.g., all N bits in one message, N/2 bits per message, N/4 bits per message, etc. in lengthening the number of bits transported in each message from one to many, additional levels of difficulty may be introduced and placed in the path of phishing attackers that employ brute-force cracking of the static passcode through trial-and-error guessing. That is, instead of requiring up to N pairing attempts to crack an N bit passcode, where each pairing attempt compels the phishing attacker to guess one of two possible values (e.g., a binary one or binary zero value) for the corresponding N-th bit, embodiments of the invention may alternatively provide up to P pairing attempts for an N bit passcode, where each pairing attempt alternatively compels the phishing attacker to guess one of 2^{M} possible values (i.e., P=the number of subsets in which the N bits are divided; M=the number of bits defining each subset). Further, one of ordinary skill will appreciate that it is not required that each of the P subsets has the same number of bits.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for monitoring wireless sensor node security, comprising:
establishing a connection with a wireless sensor node (WSN);
retrieving log information from the WSN;
analyzing the log information to obtain a log analysis result;
detecting an intrusion based on the log analysis result; and
performing an intrusion mitigation action (IMA) in response to detecting the intrusion.

2. The method of claim 1, wherein log information comprises pairing activity information between the WSN and other devices.

3. The method of claim :I, wherein log information comprises connection activity information between the WSN and other devices.

4. The method of claim 1, wherein log information comprises data transfer information between the WSN and other devices.

5. The method of claim 1, wherein analysis of the log information is performed locally on an authorized gateway node (AGN).

6. The method of claim 1, wherein analysis of the log information is performed remotely on an authorized user system (AUS).

7. The method of claim 1, wherein the IMA comprises issuing a hard reset command to the WSN.

8. A wireless sensor network, comprising:
at least one wireless sensor node (WSN); and
an authorized gateway node (AGN) wirelessly connectable to the at least one WSN, and programmed to:
establish a connection with a WSN of the at least one WSN;
retrieve log information from the WSN;
obtain a log analysis result based on the log information;
detect an intrusion based on the log analysis result; and
perform an intrusion mitigation action (IMA) in response to detecting the intrusion.

9. The wireless sensor network of claim 8, wherein the WSN comprises memory, wherein at least a portion of the memory restricts a modification of data written therein, wherein the log information is retrieved from the portion of the memory.

10. The wireless sensor network of claim 9, wherein the WSN further comprises a computer processor for processing instructions, a wireless transceiver for communicating wirelessly with another device, at least one sensor for obtaining sensory information, and a power source for powering the memory, the computer processor, the wireless transceiver, and the at least one sensor.

11. The wireless sensor network of claim 10, wherein the WSN further comprises at least one action element for effecting a physical change in an environment.

12. The wireless sensor network of claim 10, wherein a portion of the processing instructions comprises instructions for writing information associated with at least one of pairing activity, connection activity, and data transfer activity, between the WSN and at least another device, to the memory.

13. The wireless sensor network of claim 12, wherein the at least another device initiates an unauthorized wireless connection with the WSN.

14. The wireless sensor network of claim 8, wherein the AGN is further programmed to analyze the log information to obtain the log analysis result.

15. The wireless sensor network of claim 8, further comprising:
an authorized user system (AUS) operatively connected to the AGN through a network,
wherein the AGN is further programmed to delegate an analysis of the log information to the AUS, to obtain the log analysis result.

16. The wireless sensor network of claim 15, wherein the AGN comprises a wireless transceiver for communicating wirelessly with the at least one WSN, a computer processor for processing instructions, memory for storing at least the log information, at least one network interface for communicating with the AUS over the network, and a power source for powering the wireless transceiver, the computer processor, the memory, and the at least one network interface,

17. A non-transitory computer readable medium (CRM) comprising computer readable program code, which when executed by a computer processor, enables the computer processor to:
establish a connection with a wireless sensor node (WSN);
retrieve log information from the WSN;
analyze the log information to obtain a log analysis result;
detect an intrusion based on the log analysis result; and
perform an intrusion mitigation action (IMA) in response to detecting the intrusion.

18. The non-transitory CRM of claim 17, wherein log information comprises pairing activity information between the WSN and other devices.

19. The non-transitory CRM of claim 17, wherein log information comprises connection activity information between the WSN and other devices.

20. The non-transitory CRM of claim 17, wherein log information comprises data transfer information between the WSN and other devices.
